(19) United States
(12) Patent Application Publication
(10) Pub. No.: US 2016/0240037 A1
(43) Pub. Date: Aug. 18, 2016

(54) SYSTEM AND METHOD FOR NETWORK-BASED SECOND CHANCE PLAY WHILE AWAY LOTTERY USING A GRAPHICAL USER INTERFACE

(71) Applicant: WMS Gaming Inc., Waukegan, IL (US)

(72) Inventors: RICHARD B. ROBBINS, Glenview, IL (US); JAMIE W. VANN, Chicago, IL (US)

(21) Appl. No.: 14/624,046

(22) Filed: Feb. 17, 2015

(51) Int. Cl. G07F 17/32

(52) U.S. Cl. CPC G07F 17/329; G07F 17/3211

(57) ABSTRACT

A gaming system includes a client terminal, a lottery system, and a gaming server enabling player participation in a multiple component lottery game to win prizes. Players play a ticket-based lottery game and obtain validation codes to participate in a network-based lottery game with a specific prize structure. The network-based lottery game ticket component includes a validation code linked to a game redemption algorithm for validating and redeeming the game component. Each network-based lottery game player is associated with a player profile and a player avatar having characteristics reflecting parameters of the player profile. The characteristics of the player character avatar adapt to changes in the parameters of the player profile as players interact, using a graphical user interface, with a virtual environment during the network-based lottery game. When the network-based lottery game ends, prizes are awarded to the player in accordance with one more parameters of the player profile.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, apparatus, and methods and, more particularly, to a system and method for enabling a network-based second chance, play-while-away type lottery game, using interactive virtual environment and virtual avatar characters to engage players in the network-based lottery game.

### BACKGROUND OF THE INVENTION

Lottery games have become a time honored method of raising revenue for state and federal governments the world over. Traditional scratch-off and on-line games have evolved over decades. Both lotteries and their service providers are regularly searching for new forms of gaming.

In the past, United States lotteries have used the Internet as a vehicle for disseminating information about their lottery organizations, their games, and their promotions. They have also used the Internet for simulations of classic instant ticket games, games solely for entertainment without a fee, a means to communicate with players, for selling subscriptions to traditional lotto games.

Second chance drawings may be implemented as a means to award prizes to holders of non-winning lottery tickets. Second chance drawings are also used as temporary promotions to give game sales more value to lottery players. Additionally, United States Lotteries have come to appreciate the virtues of producing games with more entertainment value that can be sold at a premium price, for instance, ten-dollar scratch ticket games with higher paybacks and more ways to win. Making Internet delivered games part of the prize structure for extended play tickets is expected to appeal to both players and lottery administrators.

Moreover, as gaming technology and systems continue to evolve and become more sophisticated, numerous new types of lottery related games and products become available that require discrete new methods of funding and enabling.

Thus, it is highly desirable to develop a lottery ticket platform that provides methods of funding Internet and new gaming opportunities.

### SUMMARY OF THE INVENTION

According to another aspect of the invention, a computer-implemented method indicating player account parameters using visual characteristics on an electronic display device coupled to a network is disclosed. The method includes issuing a lottery ticket including a unique activation code in response to receiving a wager amount. Computerized game-logic circuitry, responsive to a physical input on an electronic input device by a player, receives a resultant activation request activating the activation code associated with the lottery ticket. The game-logic circuitry links the activated activation code to a player-accessible account associated with a virtual character. The game-logic circuitry further establishes one or more visual characteristics for the virtual character based, at least in part, on measurable parameters of the player account. The game-logic circuitry provides a player-interactive virtual environment including the virtual character by generating display information for rendering the virtual environment and the visual characteristics of the virtual character on the electronic display device. The game-logic circuitry also directs the electronic display device to update the virtual environment and the visual characteristics of the virtual character based, at least in part, on changes in the parameters of the player account as changes to the parameters occur.

According to one aspect of the present invention, a gaming system for implementing a network-performed indication of player account parameters using visual characteristics on an electronic display device coupled to a network is disclosed. The system performs the network-performed indication of player account parameters following the issuing of a lottery ticket including a unique activation code in response to receiving a wager amount. The system comprises game-logic circuitry comprising one or more processors, at least one storage medium, and at least one communication interface coupled to the network. The game-logic circuitry is configured to receive an activation request activating the activation code associated with the lottery ticket, responsive to a physical input on an electronic input device by a player. The game-logic circuitry links the activated activation code to a player-accessible account associated with a virtual character. The game-logic circuitry establishes one or more visual characteristics for the virtual character based, at least in part, on measurable parameters of the player account. The game-logic circuitry provides player interaction using a player-interactive virtual environment. The player-interactive virtual environment includes the virtual character and is generated from display information for rendering the virtual environment and the visual characteristics of the virtual character on the electronic display device. The game-logic circuitry directs the electronic display device to update the virtual environment and the visual characteristics of the virtual character based, at least in part, on changes in the parameters of the player account as the parameters change.

A method of indicating player-accessible account characteristics on an electronic display device coupled to a network is disclosed. The method comprises providing a graphical user interface for displaying a player-interactive virtual environment. A lottery ticket including a unique activation code is issued in response to receiving a wager amount. Responsive to a physical input on an electronic input device by a player, game logic circuitry receives an activation request over the network from the player to activate the activation code associated with the lottery ticket. The game-logic circuitry links the activated activation code to the player-accessible account associated with a virtual character. The game-logic circuitry establishes one or more characteristics for the virtual character based, at least in part, on measurable parameters of the player account. The game-logic circuitry generates information defining features of the virtual environment and transmits the information over the network for display of the graphical user interface to the player on the electronic display device. The game-logic circuitry provides a player-interactive virtual environment using the graphical user interface that includes the virtual character. Display information is generated for rendering the graphical user interface including the virtual environment and the visual characteristics of the virtual character on the electronic display device. The game-logic circuitry directs the electronic display device to update the graphical user interface, the virtual environment, and the one or more characteristics of the virtual character based, at least in part, on changes in the parameters of the player account.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1A is a schematic view of a gaming system according to an embodiment of the present invention.

FIG. 1B is a schematic view of a gaming system according to an embodiment of the present invention.

FIG. 2A is a view of the front of an exemplary scratch lottery-type instant ticket having the Scratch-Off-Coating (SOC) removed revealing a non-winning standard instant ticket coupled with a validation code for an on-line second chance game.

FIG. 2B is a view of the back of the exemplary scratch lottery-type instant ticket FIG. 2.

FIG. 3 is a flowchart for an exemplary process for a player to enter lottery ticket validation codes and participate in a network-based lottery game.

FIG. 4A is a view of the graphical user interface used by a player to conduct a network-based lottery game.

FIG. 4B is a view of the progression of the network-based lottery game.

FIG. 4C is a view of a player virtual character having updated appearance characteristics based on measurable parameters of the player account.

FIG. 4D is a view of the conclusion of a portion of the network-based lottery game.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

In accordance with one embodiment of the invention, a method is provided for implementing a ticket-based, multi-component lottery game. The method includes providing lottery tickets for players, wherein the lottery tickets include a first game component with a first prize structure and one or more additional game components with a separate second prize structure. A first validation code is provided on the lottery ticket. The first validation code is linked to a first game redemption algorithm in a server for validating and redeeming the first game component of the lottery ticket. One or more additional validation code(s) provided on the lottery ticket are linked to one or more separate redemption algorithms for validating and redeeming the additional game component(s) of the lottery ticket. Validation and redemption of the lottery ticket for the first and additional game components is enabled with separate redemption acts that do not necessarily include cross-communication between the first and additional game redemption algorithms. For example, the lottery ticket may be validated and redeemed for the first game component at a first redemption time that is different than any additional redemption times for any additional game components, and at a first location that is different than any other location(s) for additional game component(s). In alternative methods, the first and additional game components are redeemable at the same location at different times.

In one embodiment, the first game component is an instant-win lottery game, such as a scratch-off lottery game, wherein the outcome of the first game component is presented to the player on the lottery ticket, or an on-line lottery game wherein the outcome of the first game component is dependent on a subsequent random generation event or predetermined, but printed at the time of purchase. The additional game component may be, for example, an interactive network-based lottery game, with the method further comprising providing an access code on the lottery ticket that enables the player to access a web site for play of the additional game component. In one embodiment, the prize for the network-based lottery game is predetermined and dictated by the additional validation code, but is only made aware to the player upon play of the network-based lottery game. In another embodiment, the prize for the network-based lottery game is randomly determined during the course of the network-based lottery game and is associated with the additional validation code instead of being predetermined as discussed above. Alternatively, prizes may be determined by actual play of the network-based lottery game, a random number generator, a sequential validation file, or hash file, or a variety of other means.

In one embodiment, player participation with the network-based lottery game is required to be eligible for available prizes. Further, the player is associated with a profile and at least one virtual character avatar having one or more visual characteristics representing one or more quantitative parameters of the player account. Player avatars may include visual indications of parameter values that may include the number of validated and registered network-based lottery game entries, a current value of one or more currency variables (virtual or actual) related to the player account, or a number of winning network-based lottery game random draws, to name a few.

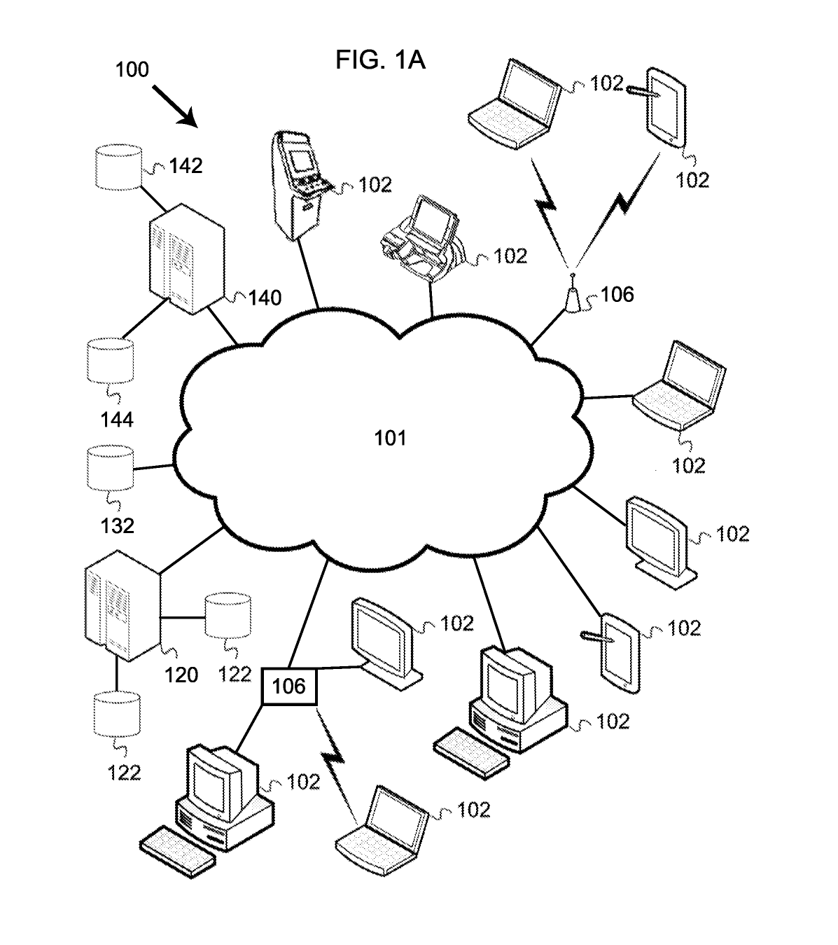

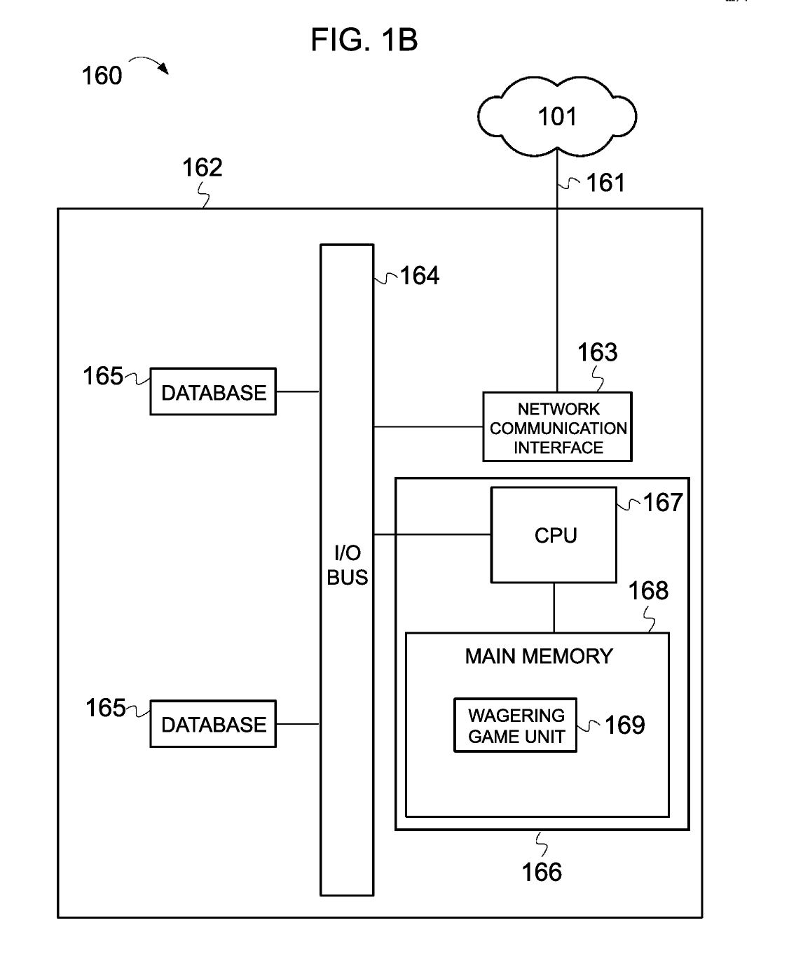

FIG. 1A is a schematic view of a gaming system 100 according to an embodiment of the present invention. Gaming system 100 includes a network 101 with various client terminals 102 coupled thereto. The network 101 is communicative in nature and function, and may be realized as a local area network (LAN), a wide area network (WAN), or a combination of the two, as an Internet. Client terminals 102 may include personal computers, laptops, kiosks, lottery terminals, consumer tablets, smartphones, watches, etc. The client terminals 102 may be coupled the network 101 directly, via an intermediary Internet Service Provider (ISP) (not shown), or via a network access point 106 that may include wired connectivity, wireless connectivity, or both. The network access point 106 may include consumer routers, cell phone towers, wireless repeaters, WiFi or Bluetooth devices, mobile hotspots, etc. Any suitable means and methods for network connectivity are envisioned as providing the required communicative requirements for any or all of the network client terminals 102 with each other and other network entities as shown.

Also coupled to the network 101 are systems that may be operated by a lottery authority, for example, a State or another lottery regulating or dispensing entity. These systems may include a lottery central site system server 120 and one more accompanying databases 122. The databases 122 may include information relating to specific games or tickets, for example, an instant ticket database for a complete game or partial production run set of tickets, an on-line drawing database containing all of the unique ticket identifiers from produced tickets for verification, and/or a database of validated or redeemed winning lottery tickets. The information stored and controlled by lottery server 120 may be highly variable and the databases 122 may include any amount of information related to the lottery and associated tickets divided and stored in any number of ways. Databases may span multiple physical devices on one or more sections of the network 101 and be segmented to store information in any number of distinct, separately addressable database portions.

Other types of tickets and lottery games information databases 132 may also be accessible over the network 101 to provide or store information related to other lottery related systems (such as lottery terminals 102). These databases 132 may be routinely synchronized, duplicated, or migrated to and from the lottery server 120, and/or other databases 122, 132, 142, to enable more diverse information access methods for information gathering and reporting.

For example, a related or identical copy of an on-line database 132 may also be delivered to database 142 to the web server 140 running one or more network-based lottery games. This copy of the database may be used by the server to determine the authenticity of received unique ticket identifier data, ensure that no ticket identifier is credited twice, and to generate the correct ticket identifier codes for the tickets associated with winning games (i.e., where the consumer wins with a lottery ticket or redeems a code for a network-based lottery game) stored in a winning player database. It should be noted, that a related or identical copy of the on-line database(s) 132 may be replaced solely with the on-line database 122 resident at the lottery central site server 120, thereby having all network-based lottery gaming transactions conducted by the lottery server 120. While it is possible for databases and functionality to be added for implementing network-based lottery gaming on existing lottery servers 120 not originally designed to accommodate this type of interface, it may be preferable to implement network-based functionality on separate, multiple, and distributed servers for ease of integration and operational efficiency. Obviously, these distributed servers could be physically located at the same location as the existing lottery server 120 or be alternatively located on the network 101 in any topological configuration.

FIG. 1B is a block diagram illustrating a network-based lottery game server 160 in one embodiment. The network-based lottery game server 160 may be a specialized computing unit configured specifically for performing the network-based lottery game, among other things. For example, the network-based lottery game server 160 may include functions that are similar or identical to other network entities (e.g., the lottery server 120 and/or web server 140), and may additionally perform other network tasks including database management and load balancing, for instance. For example, the network-based lottery game server 160 may serve web pages on request or act as a liaison, agent, or proxy between requesting clients (that may be other system servers like lottery server 120) and information databases (for example, databases 132, 142, 144). In other embodiments, one or more network-based lottery game servers 160 may be used, for example, for distribution of request loads to various network servers to mediate impact on network and computer usage. Details regarding these server operations are not disclosed in detail here for the sake of brevity.

The network-based lottery game server 160 includes a secure cabinet 162, housing various components. The secure cabinet 162 is coupled to the communicative network 101 via a communications medium 161. The communications medium 161 may comprise wired and/or wireless communication links employing any suitable connection technology, such as Bluetooth, 802.11, Ethernet, public switched telephone networks, SONET, etc., using any communication protocol to effect communication between computing elements over the network 101. Communications between network-based lottery game server 160 and other network entities occur over communication medium 161 via a network communication interface 163 that formats digital information into interpretable messages for delivery.

The network communication interface 163 is electrically coupled to an internal input/output (I/O) bus 164 of the network-based lottery game server 160. The I/O bus 164 may include any suitable bus technology to effect digital communication between components, such as an AGTL+ frontside bus and a PCI backside bus.

The I/O bus 164 may also be connected to one or more databases 165, such as databases 122, 142, and/or 144 shown in FIG. 1A. It is also possible that database 165 be distinct from and/or remotely located from the network-based lottery game server 160, accessed via the network communication interface 163 or another communicative coupling (e.g., Universal Serial Bus (USB), Firewire (IEEE 1394), Thunderbolt, secured WiFi, etc.).

The network-based lottery game server 160 also includes game-logic circuitry 166 coupled to the I/O bus 164. The game-logic circuitry 166 comprises a central processing unit (CPU) 167 connected to main memory 168. The CPU 167 can include any suitable processor, such as an Intel® Pentium processor, AMD processor, or UltraSPARC processor. The main memory 168 includes a wagering game unit 169. In one embodiment, the wagering game unit 169 performs the functions of the network-based lottery game, in whole or part. The wagering game unit 169 may also perform random number generation when necessary to resolve events in the network-based lottery game, such as player-initiated lottery drawings, randomized item ordering, etc.

In one embodiment, the network-based lottery game server 160 utilizes game-logic circuitry 166 to create and manage a virtual environment that includes virtual avatars by generating display information delivered to client terminals 102 to enable players to interact with the virtual environment and virtual avatars of a network-based lottery game. The game logic circuitry 166 delivers display information for rendering content to the player in addition to receiving and interpreting interaction input information from the players over the network (signals and messages resulting from a player providing physical input). The game logic circuitry 166 may additionally manage various database functions to allow information filtering for specific content display (e.g., avatars associated with the player), verification and validation of received authentication codes (e.g., lottery ticket validation codes entered by a player), and/or verification of authentication information for redeeming game components in accordance with determined outcomes of the network-based game.

In general, the main memory 168 and/or the wagering game unit 169 stores programming that includes a random number generator (RNG), game-outcome logic, and game assets (e.g., virtual environment avatars, art, sound, etc.)—all of which have typically obtained regulatory approval from a gaming control board or commission and are verified by a trusted authentication program in the main memory 168 prior to game execution. The authentication program may generate a live authentication code (e.g., digital signature or hash) from the memory contents and compares it to a trusted code stored in the main memory 168. If the codes match, authentication is deemed a success and the game is permitted to execute. If, however, the codes do not match, authentication is deemed a failure that must be corrected prior to game execution. Without this predictable and repeatable authentication, the network-based lottery game server 160 (and/or an external network entity 102, 120, 140, etc.) are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a network-based lottery game is executed, the CPU 167 (comprising one or more processors or controllers) executes the RNG programming to generate one or more pseudo-random numbers, if necessary. The pseudo-random numbers are divided into different ranges, and each range is associated with a respective game outcome or a respective validation code or player account. Accordingly, the pseudo-random numbers are utilized by the CPU 167 when executing the network-based lottery game logic to determine a resultant outcome for that instance of the network-based lottery game. The resultant outcome may be presented to a player at a terminal 102 by generating information delivered to terminal 102 for rendering one or more aspects of the virtual environment. The CPU 167 causes display information to be generated and delivered to the terminal 102 based upon the game assets to be presented to the player (e.g., audio and video presentations).

Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key or input gathered from a sensor) and cycles continuously in the background between games and during game play at a speed that cannot be timed by the player, for example, at a minimum of 100 Hz (100 calls per second) as set forth in a number of regulatory statues. Accordingly, the RNG cannot be carried out manually by a human and is integral to operating the game.

In one embodiment, the network-based lottery game server 160 can include additional peripheral devices and/or more than one of each component shown in FIG. 1B. For example, in one embodiment, the network-based lottery game server 160 can include multiple network communication interfaces 163, multiple database 165, and/or multiple CPUs 167. In one embodiment, any of the components can be integrated or subdivided, and even distributed to other functional components on the network 101.

Components of the network-based lottery game server 160 architecture may include hardware, firmware, and computer-readable media including instructions for performing the operations described herein. The other network components (e.g., client terminals 102) may include hardware and computer-readable media including instructions for performing operations described herein. Various combinations of one or more computer-readable medium(s) may be utilized. The computer readable-medium may be a computer-readable signal medium or a computer-readable storage medium. Some examples (a non-exhaustive list) of the computer-readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer readable medium that is not a computer readable storage medium and that can communicate, propagate, or transport a program for use by or in connection with an instruction execution system, apparatus, or device. Program code embodied on a computer readable medium may also be transmitted to functional components using any appropriate medium, including but not limited to wireless, wireline, optical fiber cable, RF, etc., or any suitable combination of the foregoing.

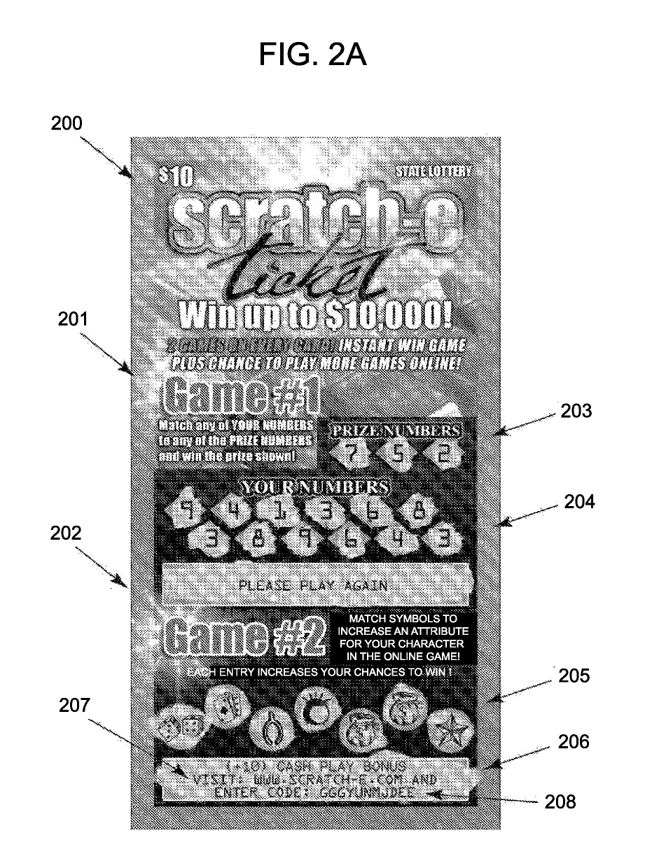

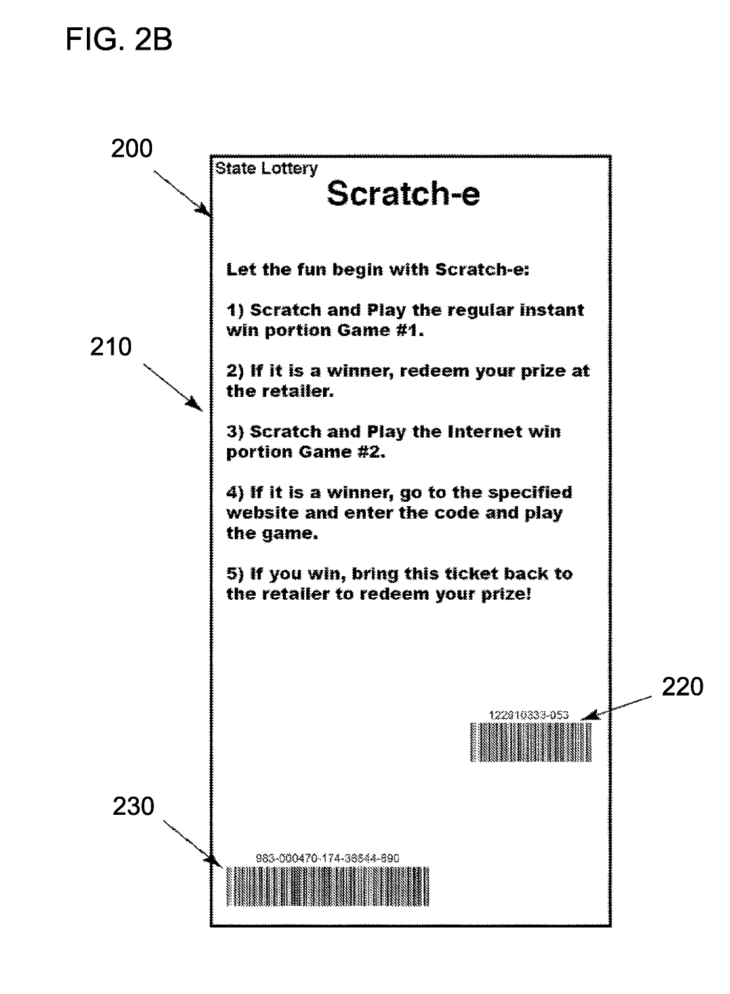

Referring now to FIG. 2A, an exemplary scratch lottery-type instant ticket 200 is shown in one embodiment, having portions of the scratch-off coating of the instant ticket 200 removed. The ticket 200 has two distinct components, a standard instant ticket game 201 and a network-based lottery game portion 202 wherein participants of the network-based game are allowed to create an on-line profile and play an additional interactive game over network 101, for example, the Internet.

Lottery tickets such as ticket 200 may have ticket sections coated with removable Scratch-Off-Coatings (SOCs) obscuring indicia until the SOC is physically removed by a consumer after the ticket is purchased. The instant lottery ticket 200 is provided as one embodiment of a lottery ticket having multiple, distinct games thereon, but it should be understood that other lottery-type tickets, for example, on-line tickets printed in real time or lottery tickets generated by a terminal printer, may be used to generate and dispense a suitable lottery ticket 200 for use with the invention, and may be more desirable in some applications. In this embodiment, the ticket 200 resembles a traditional instant win scratch-off ticket and can be purchased in the normal manner at a lottery retailer. After purchase, the consumer removes the SOC in various regions to reveal the previously hidden, win/lose indicia data (203, 204, 205) and activation code indicia data (206). After revealing the secondary game indicia data 206, the consumer may use a public lottery terminal, kiosk, computer, smart telephone, or other network device terminal 102 to visit the directed web site address 207 using a network browser or other specialized application to enter the activation code indicia data 208. For example, an arbitrary client terminal 102 may be used to manually enter the network address information, use a camera with optical text recognition, or otherwise translate address information using a Quick Response Code (QR code) or equivalent encoding means. In one embodiment, the web site address 207 directs traffic from the player client terminal 102 to the appropriate web server 140.

In this embodiment, the price of the ticket 200 would include a chance to play network-based lottery game(s) portion 202 in addition to funding the standard instant portion 201 of the ticket 100. Of course, playing (entry into, or effected account attribute increase) of the network-based lottery games themselves could be offered as a prize of the instant portion 201 (in addition, or distinct from the second game). Typically, the network-based lottery game portion 202 offers access to on-line games that include possible prizes at their conclusion, but may also include a purely amusement-valued game. Thus, there is an advantage of potentially greater appeal and suspense for a consumer playing the network-based lottery game portion 202 of the ticket 200 in this embodiment.

Assuming the network-based lottery game offered has the potential to win additional monetary prizes there may be numerous methodologies available for a consumer to receive winnings from the lottery. For example, the consumer could request a check, or direct deposit to a specified account, or debit card account, or request a credit transfer to another game directly through a network interface including a browser or application resident on a client terminal 102. Alternatively, the network interface could allow the consumer to print a ticket coupon, receipt, or voucher on a local printer that would include a unique redemption code identifiable by a participating lottery terminal available throughout its jurisdiction. Another alternative would be for the consumer to transfer an electronic voucher to another portable medium (e.g., smart telephone) that enabled redemption at a retailer location (e.g., via scanning a displayed voucher barcode). Yet another alternative would be for the ticket 200 to have its own separate validation code as specifically detailed in FIG. 2B.

Referring now to FIG. 2B, the back side of the exemplary scratch lottery-type instant ticket 200 is shown in one embodiment. The back side of ticket 200 includes instructions 210 for participating in the network-based lottery game, a separate validation code 220, and a ticket inventory number code 230. The validation code 220 relates specifically to the network portion of the ticket 200 indicating a separate prize fund/redemption system than the standard instant ticket inventory number 230. The validation code 220 and the ticket inventory number code 230 could be embodied as a barcode, a human readable alphanumeric code, or alternatively embodied using other means including a magnetic stripe, OCR (Optical Character Recognition), star code, QR code, etc.

The validation code 220 has the advantage of being readily adaptable to existing lottery redemption systems without impacting the standard instant ticket inventory control barcode 230. For example, in one possible embodiment the validation code 220 could emulate the structure of the lottery's existing on-line ticket (e.g., Powerball, Pick 3, Pick 4, etc.) data structure. Tickets that are dynamically generated by a lottery terminal 102 (that are purchased and issued to consumers in exchange for a lottery wager) may have a verification code or serial number that records the lottery wager for a future drawing. When the future drawing occurs, the previous wagers stored in the on-line database may be scanned to determine the winners. After the post-drawing scan is completed, winning on-line ticket serial numbers may be automatically credited with the correct winning amounts. Thus, by emulating the structure of the lottery's existing on-line ticket data structure in a network ticket unique separate validation code 220, the network portion of the tickets 200 could be readily sold without allowing any redemption until the network-based lottery game is played on a network, for example, the Internet. The existing lottery on-line system could readily accomplish this scenario by initially logging separate validation codes 220 on tickets for one or more future drawings. When the consumer completes on-line play of the network-based lottery game, the system will calculate the cash equivalent and log the credit to the associated separate validation code 220 in a drawing winners' file or profile stored on an internal database 144. Periodically, for example, once every twenty-four hours, the drawing winners' file would be transferred from the web server(s) 140 and loaded onto the lottery's existing validation system. Once loaded, the lottery validation system would then instruct a retailer to pay the consumer the amount credited when he or she completed the network portion of the game. To assist in database management, the separate validation code 220 can be algorithmically linked to the activation code indicia data 208 so long as the, hidden until purchased, indicia data 108 cannot be deduced from the, readily displayed, validation code 220. Alternatively, the validation code 220 and indicia data 208 could be two algorithmically unrelated blocks of data only linked by a secure database (for example, database 122). Additionally, in this embodiment where the validation code 220 is linked to a specific drawing, there may be some notice given to the consumer that “Winning tickets can be redeemed twenty-four hours after cashing out” or words to the same effect.

In another embodiment, where the outcome of the network portion 202 of the ticket 200 was predetermined by the activation code indicia 108 hidden under the SOC 106 until the ticket was purchased, the validation code 220 could function as a pointer to a standard instant ticket validation file (for example, database 122), with predetermined payouts for winning tickets. However, in this embodiment, even though the prize outcome is preordained by the activation code 208, the outcome of the network play could remain unknown to the consumer until play of the network-based lottery game has been completed. At that point the player could take their ticket 200 to a lottery retailer who would scan the validation code 220 and award a prize. Another feature of this and other similar embodiments is that, since the validation code 220 is separate from the standard instant ticket inventory control barcode 230, the ability to cash the special network portion 202 of the ticket 200 could be delayed by one or more services executing on a network lottery server 120 until after the network-based lottery game has been played or completed. In this embodiment, since the standard instant ticket barcode 230 is separated from the validation code 220, the consumer could cash winning instant ticket portions 201 at a different time than the network-based portion 202—e.g., cashing the standard portion 201 shortly after purchase is allowed by the lottery server 120, but the network-based portion 202 prizes may only be credited after play of the network-based lottery game.

In another embodiment, where the outcome of the on-line network-based portion 202 of the ticket 200 is determined by one or more drawings in the future, either initiated by the lottery system 120, the web server 140, or input received from the player, the current prize payout for a ticket 200 may or may not be available at a given time. For example, a ticket 200 may have a current value that may be immediately cashed, and also retain potential value for future drawings. In some embodiments, the player may have the ability to initiate lottery draws that will result in awarding prize amounts to the registered players of one or more particular validation codes 220. In other embodiments, registered players may become eligible for future drawings, or increased prize amounts over time. Thus, the actual and potential value of a given ticket 200 may or may not be determinable until a specific date/time, or a particular event has taken place.

Further, it is possible that a ticket 200, identified by validation code 220 and/or ticket inventory number code 230, may be used as an access card linking to a player account, file, or profile. The player profile may specify funds that may be used to retrieve cash, purchase additional tickets, or transfer contents between accounts of various types. In these and similar scenarios, a collaborative relation exists between the lottery server 120, the web server 140, and any additional servers (not shown), in addition to the databases housing player account information, ticket code information, validation information, etc. Thus, a player may be enabled to control access and transactions to account information in addition to managing participation in one or more network-based games associated with the player and player account.

A lottery server 120 may act as a specific interface between a validation file for the network-based portion of a game and a validation file for the non-network-based game or non-network-based portion of a game. For example, presenting the ticket 200 to obtain validation results and validating prizes for payment during communication with the lottery server 120 could result in only the non-network-based lottery game or games being validated with a message delivered to the validating terminal 102 that the network-based portion of the ticket has not been accessed or played. Conversely, if the lottery server 120 has authorized one or more aspects of a player account, the prize or prizes on the network-based portion or portions of the ticket validate and prizes can be paid in addition to the non-network-based portion, thereby enabling new play styles for lottery type games.

Yet another feature of this type of configuration is that it helps to introduce the concept of a lottery server 120 that regulates game play. A lottery server 120 may be composed of hardware and/or software that control the play of lottery games. This control can be exercised in multiple manners. For example, a lottery server 120 can be utilized to ensure that the network-based portion of a ticket 200 is played before allowing validation of that portion. In other words, a lottery server 120 could be configured to not impact validation of the non-network-based portion of a hybrid ticket (allowing validation for the non-network-based portion immediately after the sale of the ticket), while preventing the system from validating the network-based portion of the ticket until the consumer has actually either logged onto the specified web site, created an associated account, or actually viewed, interacted with, or completed the game to determine if a prize is won. Once the consumer has played the game on the network 101, the lottery server 120 would allow redemption of the network-based portion for the ticket 200. If redemption is attempted when the lottery server 120 is not permitting (i.e., network-based portion not played in this example), a message is delivered to the validating terminal that the network-based portion of the ticket has not been accessed or played. Thus, the lottery server 120 controls gameplay by means of a consumer accessing the network (e.g., via network server 140) and entering certain indicia from the ticket that may be encrypted, linking it to the purchased ticket and supplementing the prize won on the non-network-based portion of the ticket. The advantage of the lottery server 120 in this example being that the consumer is forced to visit the specified web site and therefore be exposed to whatever advertising, information acquisition, and offers embedded into the specified web site. Additionally, the fact that the consumer is required to visit a specified network web site to find out if he or she has won a prize, most probably means that the consumer will revisit the retailer establishment after to redeem any additional winnings-thereby increasing traffic to the retailer's establishment. A lottery server 120 can be employed with standard (i.e., legacy) instant tickets as well as on-line (i.e., real-time printed tickets) and in some cases may be more desirable on traditional lottery games.

In yet another embodiment of the lottery server 120, the outcome of the game (either by skill, or RNG, or other methodology) produces a code that is added to the validation code 220 that allows the ticket 200 to be paid and may (or may not) unlock the prize amount. This code can be transferred electronically to the lottery server 120 from the network player server 140 or given to the player when completing the on-line game. In the latter embodiment, the player would give the retailer the code (e.g., 3-digit number) that, using a lottery server 120, then unlocks the special network-based portion 202 of the ticket 200 for payment. This code could also function as a decryption key that could additionally or optionally award the correct prize value. If a one-time-pad encryption technique were employed, this embodiment would have the added advantage of decrypting to various prize values depending on the decryption key. Employment of one-time-pad encryption with multiple decryption keys depending on prize amount would also require the decryption key to decode a significantly complex check code (e.g., keyed hash result of validation code 220 and prize value). This one-time-pad encryption embodiment thus having the advantage of allowing the prize value to be determined at the time of play by transferring the winning information to the system with the decryption key.

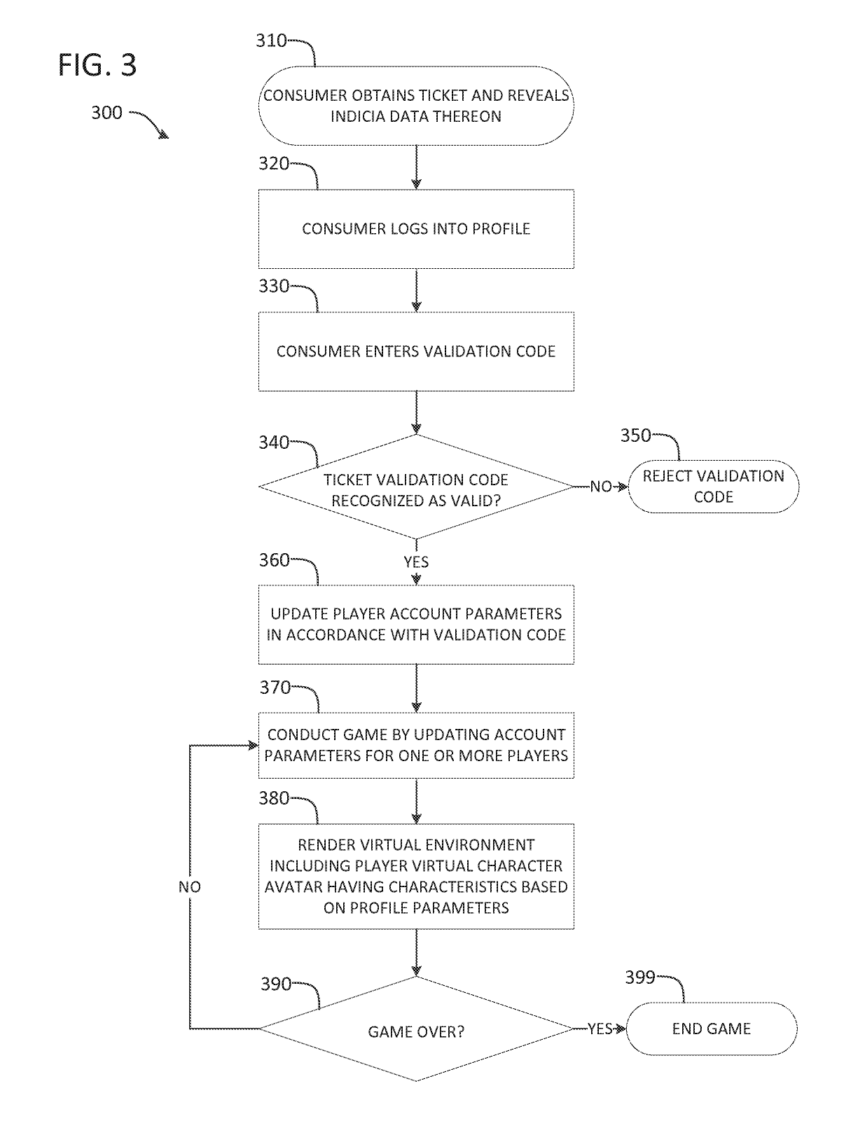

Referring now to FIG. 3, a flowchart for a process 300 detailing the entering and validation of ticket validation codes by a player is detailed in one embodiment.

In step 310, the consumer purchases a lottery ticket (for example, ticket 200), and reveals the various indicia data of the ticket (for example, indicia data 203-206). The indicia data may include symbols, win/lose indications, redeemable award(s), on-line game access information, activation code(s), validation code(s), etc.

In step 320, the consumer logs into a player profile unique to the consumer. This involves either a selection to create a new on-line player profile, or selection of a pre-existing player profile that has been previously created. Each player profile contains a set of information unique to that particular consumer player. The player profile minimally includes an assigned virtual character (avatar) for the player, and a set of one or more measurable parameters that define values for the player account specific to the network-based lottery game being implemented. Often, player profiles common to a specific network-based lottery game will have established and specifically defined fields of information. The fields that relate to the network-based lottery game may not be adjustable or modifiable directly by the player. Instead, changes to these fields occur as a result of some action taken by the player, for example, authenticating a validation code, purchasing more tickets or some form of avatar customization, initiating a lottery draw (in games where this is envisioned), or selection of a hidden item or prize in a pick field, and may also occur as a result to a game initiated event, such as a draw or prize award.

Other fields may be open to the player to specify or customize. For example, these fields may include a user name for the player account that may be specified by a player, along with a valid electronic mail address for the player, further contact information for the player (e.g., mailing address, phone number, cell/smart phone number or address, etc.), financial account details (e.g., credit card number, banking routing number, etc.), and a password for authenticating the player and gain access to the account.

Optionally, a player logging into a player account profile is directed to log into the web site via the web server 140. Player accounts profiles may be stored in a database 142, remotely located at an accessible section of the network (e.g., a database 144), or in a secured database (e.g., a database 122) retrievable only by authorized processes via a secured network terminal, for example, a lottery server 120. After the player is logged in and has authorized access to the player account profile, the player may perform various functions, including the entry of a new validation code(s), modification of player profile data, participation in the network-based lottery game, etc.

In step 330, the player is prompted to input the validation code (e.g., indicia data 208 or 220) printed on the lottery ticket 200. In the event that the on-line player profile is newly created, entry of a validation code may be a required step to continue using the web site and participating in the network-based lottery game.

In step 340, the validation code entered is checked to see if it the code is recognized among the set of outstanding codes stored in one or more of the databases of the system, for example, database 122, 132, or 142. Various forms of authentication of the validation code may occur at this stage, including the use of a specific algorithm on a remote server (e.g. lottery server 120) to verify the correct input, validity, eligibility, and subsequent cancellation of a player provided validation code. Further, a wide variety of verification notifications are possible, including network based third-party security mechanisms, use of time-based granted certificates, or public key infrastructure (PKI) mechanisms to verify and authenticate validation codes, to name a few.

In step 350, when it is determined that the validation code is invalid, for example, the player inputting a validation code that has already been redeemed or the inputted code was sensed or entered incorrectly resulting in a failed authentication, the validation code is rejected and is not associated with the player account. The player may be immediately logged off, given another opportunity to input another validation code, or ineligible to input another validation code for a predetermined period of time, to provide some examples of subsequent processing.

In step 360 after an authenticated validation code is received and verified, the validation code is associated with the player account. This may cause one or more measurable parameters to change in the player account. For example, the number of authenticated validation codes will increase. Any additional bonus granted as a result of the redeemed validation code is garnered. For example, “+10 cash play bonus” is granted to the player redeeming the validation code indicia data 208 in FIG. 2. Other derived player profile parameters may also change as a result of one or more parameter changes. For example, in one embodiment, three distinct profile parameters meeting a predetermined minimum may cause a fourth profile parameter to increase. Keeping with the fish tank example, the size and speed of a fish may increase as the number of a given parameter changes, in addition to being placed in a fish tank corresponding to a value of one or more parameters of the profile. In the event that the size and/or speed exceed a predetermined maximum for a particular fish tank, the fish may be placed in another tank (indicated by a given parameter). The movement of the fish into a new tank may result in potential modification of the size and speed parameters of the fish. Thus, as a lottery and on-line game designer sees fit, the variation of one or more parameters of a player profile may have an impact on other parameters of the player profile.

In step 370, the network-based lottery game is conducted in accordance with the specification of the on-line portion of the game, ultimately altering the player profile parameters for one or more of the players, potentially as a result of one or more of the authorized validation codes input by the player. The redemption (or absence) of specific validation codes may also impact the network-based lottery game in one or more ways. For example, the network-based lottery game may begin issuing draws after a predetermined number of validation codes are redeemed network-wide, or a specific validation code may trigger a large amount of network-based lottery game draws to occur. The network-based lottery game may include the fish tank lottery thus far described, or be one of a myriad of other possibilities as implemented on the system of FIG. 1. The specifics of the network-based lottery game are left arbitrary to accommodate a variety of embodiments that may be employed. Some examples of network-based lottery games will be detailed later in the specification.

In step 380, the virtual environment of the network-based lottery game is presented to the player. This may be performed using one or more electronic displays having some type of graphical user interface capable of displaying various aspects of the network-based lottery game to the player in addition to interpreting player input to control, customize, or otherwise impact gameplay.

The player virtual character may be a randomly assigned avatar, an avatar selected by the player from a set of available avatars, or an avatar uploaded to the gaming system (e.g., via web server 140) by the player. In the base example, the player virtual character is a fish in a specific type of fish tank dictated by one or more values of the player profile, where the fish is displayed having characteristics that reflect the values of one or more of the measurable parameters of the player profile. The measurable parameters associated with the player profile may include a wide variety of variables that may be specific to the type of network-based lottery game being performed. For instance, in one type of network-based lottery game disclosed in an upcoming section, a player fish avatar increases in size as the value of the player account reward amount increases. Alternatively, the fish avatar could increase in size in accordance with the number of ticket validation codes are associated with the account, or increase in size the number of days the player logs in to the web site to check on progress of the network-based lottery game. In another embodiment, the fish avatar may increase in size as the value of the player account reward amount increases, while changing in color in accordance with the number of ticket validation codes associated with the player account. Any singular or plural measurable parameter may be used to alter one or more of the visible characteristics of the avatar. As seen in FIG. 2, the player will receive a “+10 cash play bonus”, indicating the increase of a specific parameter variable stored in the player profile for the network-based lottery game provided by the ticket 200. The effect of this parameter may be negligible or very significant to the network-based lottery game. For example, the “cash play” parameter may ultimately alter many facets of the player experience, including odds of winning a prize, the amount of prizes won, the amount of drawings granted to the player, the set of prizes available to a player, the appearance of the player avatar, the actions of the avatar in the virtual environment, etc.

Visual display, definition, and construction of the player avatar also are quite open ended. The avatar can be modified in many ways to reflect the value of one or more measurable parameters of the player profile. In fact, there may be a specific type of rendered characteristics for the avatar after a set of measurable parameters have achieved a specified value or state. For example, the fish referenced above may flash on the player's birthday, while maintaining all other characteristics, like size and speed, based on the value of the player award and the number of validation codes registered with the player account. Another example may include the increase in size of a player avatar in an initial virtual environment until a specific value is obtained, at which point, the player avatar is transferred to another virtual environment beginning avatar growth again from a predetermined, smaller starting size.

Other players may also be part of the virtual environment in which the player interacts. Virtual characters and avatars of other players, whether currently on-line, logged in, or offline, may populate the visual field of the network-based lottery game. In some instances, these avatars are associated with the specific player, perhaps indicated as “friends” or “acquaintances” in the player profile, or randomly chosen by one or more computers and random number generators (RNGs). Optionally, one or more other rendered avatars may be randomly generated and may not correspond to actual players of the network-based lottery game.

The avatars rendered at this stage will have characteristics that correspond to the values of measurable parameters stored as part of the player profile. As these parameters change, the display and visual characteristics of the avatars will change accordingly to reflect changes in the measurable parameters. For example, as fish eat pellets worth a specific credit amount, iconic representations of credit amounts, or even other fish, the parameters of one or more player accounts may change and the network-based lottery game will reflect the changing values through the rendering of changing virtual characters and avatars.

In step 390, a determination is made as to whether the network-based lottery game is completed, or whether the network-based lottery game will continue to potentially alter one or more player parameters with future events such as player duels, lottery draws, prize awards, etc. In the event that the game continues, specifically for the particular player, flow returns to step 370 where the network-based lottery game continues with further events and lottery related occurrences.

One embodiment may include a network-based lottery game where each player profile tracks a parameter measuring a number of winning draws for each validation code and, when a fixed number of winning draws occurs for a player, the game ends for the player (but continues for other active players). Steps 370-390 would continue for the player (perhaps over several months), until the parameter(s) causing the game to end are satisfied. Once the ending of the network-based lottery game occurs, the process flow continues at step 399.

In step 399, the network-based lottery game terminates when a determination is made that the game is over for the player. This may indicate the network-based lottery game is over for all players, but this is dependent upon implementation of the details of the network-based lottery game. The ending of the network-based lottery game may be a result of the awarding of the maximum amount of prize money, the ending of a fixed time period, or the elapse of a fixed duration for the player or one or more validation code(s).

Generally, when the network-based lottery game ends, prizes are awarded to the player. This may occur by electronic transfer as previously discussed, the distribution of funds through the mail (by check), a requirement to bring a winning ticket to a lottery terminal or retailer to redeem, etc. Termination of the network-based lottery game may further include a denial of access to the network-based lottery game for the player or a removal of functions or access to the player profile.

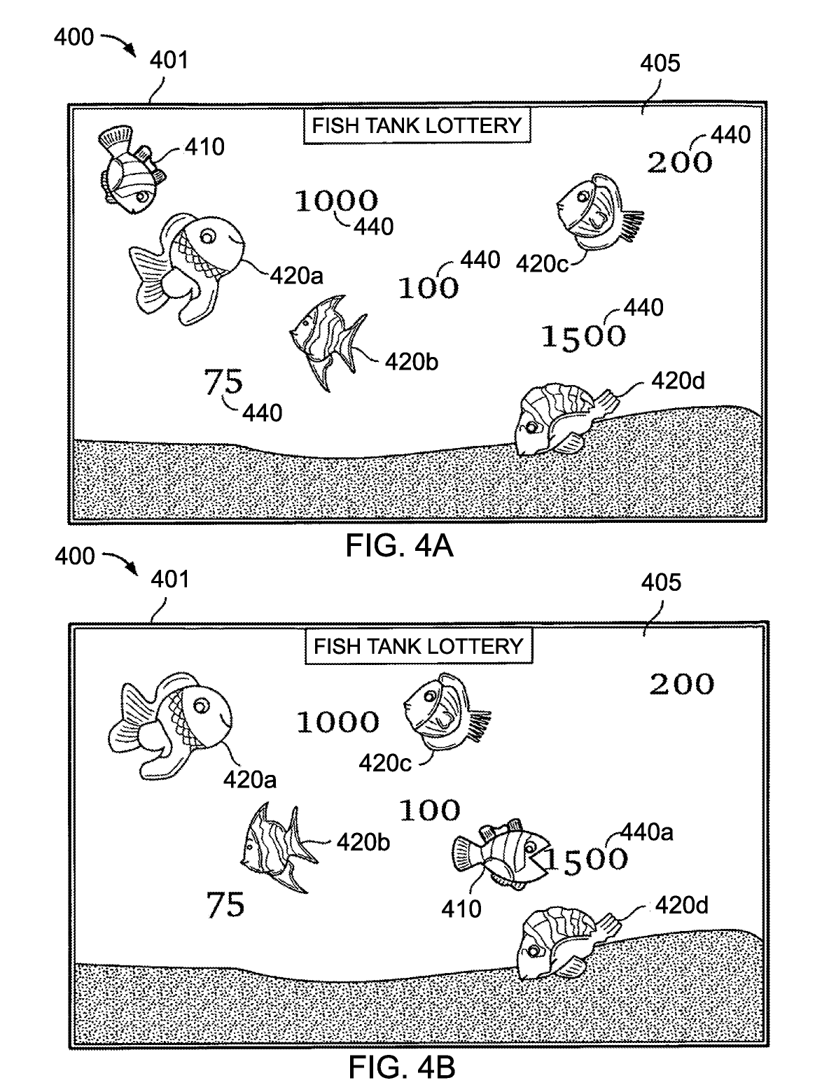

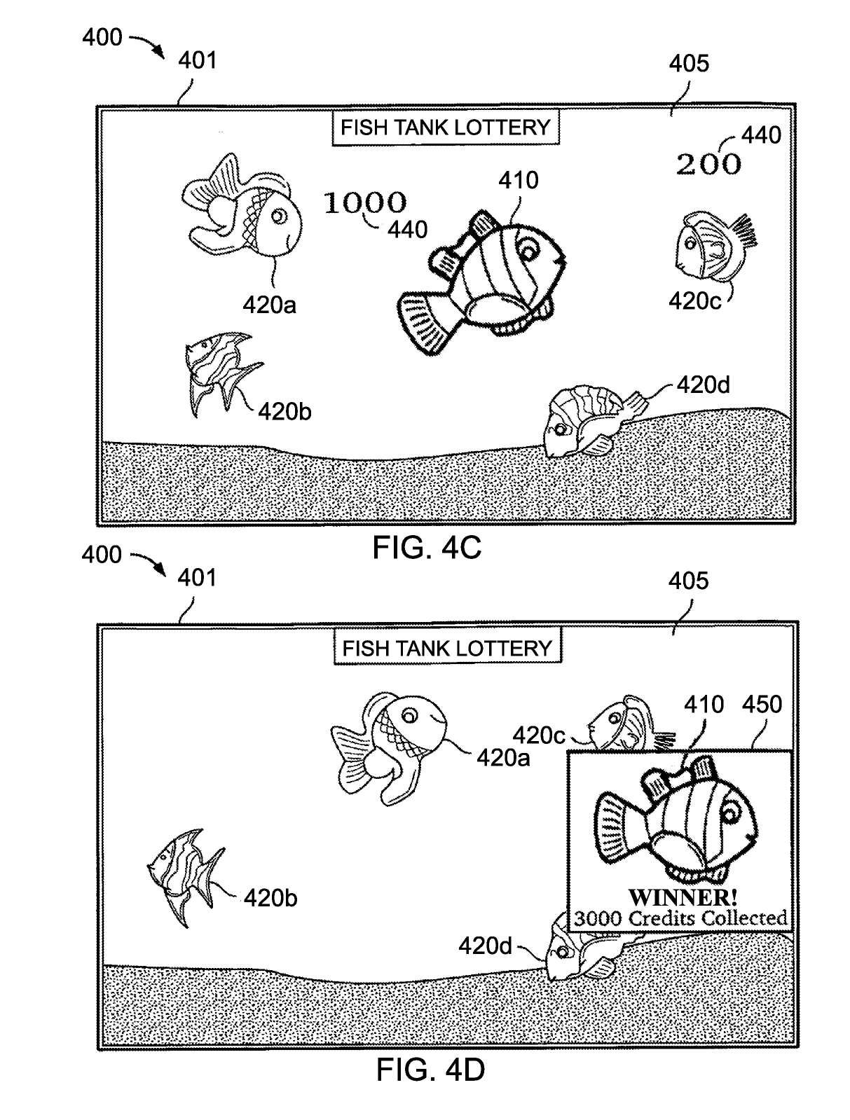

Referring now to FIG. 4A-4D, an example of a network-based lottery game is detailed in one embodiment.

FIG. 4A is a view of the electronic display 400 displaying a graphical user interface (GUI) 401 used by a player to display, conduct, and facilitate an network-based lottery game in one embodiment. The GUI 401 is presented to a player on an electronic display 400 of arbitrary type that may comprise one or more computer screens, mobile device display units, televisions, etc. The GUI 401 displays generated imagery in accordance with the programmed nature of the network-based lottery game and receives input from the player via one or more electronic input devices that may comprise touchscreens, keyboards, pointing devices (e.g., mouse), etc. It is noted any type of electronic display device and electronic input devices may be used in accordance with the disclosed invention without departing from the overall scope and spirit of the invention.

The GUI 401 displays a virtual environment 405 to the player that includes a player icon, character or avatar 410. The player avatar 410 is associated with the player through a player account or other player identifier, as described above herein. In some games, it is possible that the player may be associated with one or more avatars 410 simultaneously, but in the current embodiment, only a single avatar 410 is used.

The player avatar 410 has one or more attributes that correspond to one or more sets of measurable parameters in the player profile. The attributes may include features of the avatar 410 such as size, speed, color, dexterity, strength, skill, etc. The numerical value of the underlying parameters that are reflected by the avatar 410 may be displayed along with the avatar 410, be otherwise accessible or viewable upon selection of a button or the avatar 410 itself, or be completed hidden from the player. The player may be given opportunities to customize his player avatar 410, for example, by altering the type or gender of displayed avatar 410, via a selectable menu option or other input method that is made available at specific times or in response to the paying of a nominal fee.

As the player performs actions that impact the value of one or more parameters associated with the player account, the player avatar 410 will reflect the new parameter values by changing the attributes of the avatar 410. The reflection of the parameter value(s) of the player account will generally remain current in the visual representation of the player avatar 410 through the use of corresponding attributes.

During play of the network-based lottery game, the player may accumulate awards, points, or other eligibility criteria which qualify the player for entry and participation in other events (e.g., bonus rounds), or even further network-based lottery games. For example, certain outcomes of the network-based lottery game may provide the player with awards to play in one or more other network-based lottery games, for example bonus games to score additional awards. Events that occur in a given network-based lottery game may cause the virtual environment 405 to change in the network-based lottery game. For example, as the parameters affecting the size attribute of the player avatar 410 increases, the player avatar 410 may be placed in a different environment (e.g., a larger fish tank), or the number of player avatars displayed in the network-based lottery game may diminish as the number of total players decrease. In response to the player avatar 410 being placed into another environment, the player avatar 410 may revert back to a prior attribute (e.g., smaller fish) in the new environment, but the player avatar 410 attribute(s) in the new environment will still be representative of the corresponding parameter(s) of the player account.

The network-based lottery game may also be strictly timed based, and the capturing of awards may only occur for a short period of time once the game starts. Thus, before the network-based lottery game is initiated, it is likely beneficial for the player to increase parameters of the account in order to have any enhanced benefits and attributes for the player avatar 410. In some instances, the period of time may span several months, or be dependent upon the number of active players or the value of parameters of one or more players. Further, it may be beneficial in the network-based lottery game to continue to obtain and provide additional validation codes to enhance the parameters of the player avatar 410. In other embodiments, additional interaction may be required to remain as a participant in the network-based lottery game.

In the current embodiment, the player is represented by his player avatar 410 which enters and navigates the fish tank virtual world of the network-based lottery game. In doing so, the player avatar 410 interacts with other elements in the virtual world of the network-based lottery game, such as other fish, plants, sea life, food, awards, prizes, etc. In one embodiment, the player avatar 410 swims through the virtual world of the fish tank along with other supplemental avatars 420a,b,c,d. The supplemental avatars 420a,b,c,d may represent other players participating in the network-based lottery game, or may represent computer players, or may simply be decorative graphics as part of the virtual world. In one embodiment, the player avatar 410 navigates and interacts with the virtual world, collecting awards 440 or prizes dispersed throughout the virtual world. For example, the player avatar 410 may eat other fish, eat food, or find awards 440 and prizes floating in the water or buried in the sand at the bottom of the fish tank. In doing so, the player avatar 410 accumulates awards 440 such as credit awards and other prizes, which are credited to the player account associated with the player and the avatar 410.

In an embodiment, the amount of the awards 440 that the avatar 410 collects during participation in the network-based lottery game is dependent on one or more of the attributes of the avatar 410. In other embodiments, the awards 440 are predetermined and preselected for consumption or interaction with the player avatar 410.

In yet other embodiments, the awards 440 may be generated as a result of action by one or more players. For example, a player may be given a number of pellets for feeding fish by dropping into the fish tank. Each pellet may have a static, variable, or randomly determined award value. In this embodiment, a player initiates a lottery draw at the time the pellet is dropped into the tank by the player. When a pellet is dropped into the tank, a fish may eat the pellet, or the pellet may drop to the bottom of the tank having no fish capturing the award 440. An additional bonus may result when a player avatar 410 captures a pellet dropped by the controlling player.

The awards 440 may also be dependent upon complimentary conditions of the virtual world which are compared with the attributes of the avatar 410. For example, the virtual world may vary so as to have fast moving food (which a fast fish avatar is more easily capable of capturing and eating), strong currents (which affect smaller fish more than larger fish), deeper placement of awards (which are more easily retrieved by stronger fish), etc. Thus, one or more rule sets may be employed in the network-based lottery game so as to resolve the characteristics of the attributes of the avatar 410 against the conditions of the virtual world, and award bonus awards 440 to the avatar 410 accordingly.

In one embodiment, FIG. 4A shows the GUI 401 displaying a virtual environment 405 after the player has logged in and began interaction in the network-based lottery game. Some awards 440 are displayed in the tank of the virtual environment 405, as well as other player avatars 420a,b,c,d.

In FIG. 4B, the player's avatar 410 continues to participate in the network-based lottery game in the fish tank and interact with the virtual environment 405, as displayed by the GUI 401. As the player avatar 410 fish continues to swim about the fish tank, the avatar 410 encounters a first award 440a of 1,500 credits, which the player avatar 410 eats or consumes. The 1,500 credit award 440a is thus awarded to the player, and added to the player account associated with the avatar 410. The supplemental avatars 420a,b,c,d continue to swim about the tank and eat other awards 440, and otherwise interact within the virtual world of the network-based lottery game. By eating the other awards 440, the supplemental avatars 420a,b,c,d remove them from being available to be eaten by the player avatar 410 and awarded to the player. In an embodiment, the supplemental avatars 420a,b,c,d may directly interact or compete with the player avatar 410, such as in a race, a fight, or other competition, or even in a collaborative manner.

In FIG. 4C, an embodiment showing the player avatar 410 getting larger in response to consuming the award 440 is shown. In this embodiment, the player avatar 410 reflects the “credits accrued” using a size attribute characteristic. In response to the fish consuming the 1,500 credit award 440a, the player avatar is enlarged considerably. In this embodiment, as the fish grow in size, it may become clear which fish have been in the tank the longest (and/or most often) providing a sense of status to players. Coupling this functional behavior with social networking and the simultaneous use of arbitrary groups of avatars 410, 420, players may be able to track advancement of themselves and other players, compete with others, work collectively with others, and gain status or notoriety in a set of players.

The player avatar 410 continues to swim about the virtual world of the supplemental wagering game 405 and collect awards 440 so long as the network-based lottery game continues. That is, the player continues to participate in the network-based lottery game until a given triggering event occurs, for example, player time expires, the lottery game is terminated, or the player and avatar 440 has achieved all that is possible. The expiration of the network-based lottery game, or even a phase of the network-based lottery game, may be dictated by a random event or by a predetermined determination.

As seen in FIG. 4D, the player fish avatar 410 has collected a total of 3,000 credits during this portion of the network-based lottery game. An information banner 450 pops up which includes an image of the player avatar 410 and a message indicating that the current “feeding” session has expired. Alternatively, the information banner 450 may report that the network-based lottery game has terminated, along with an explanatory reason. The information banner 450 further includes a summary of the credits and awards 440 won by the player avatar 410, in this instance, 3,000 credits. The credits, prizes and awards accumulated by the avatar 410 during the network-based lottery game are credited to the player account associated with the player and the player avatar 410. The player can learn the amount of bonus awards 440 earned during the network-based lottery game by checking his player account balance, for example, by referencing an online profile viewer made available by network server 140.

In other embodiments, other triggering events may be used to terminate player participation in the network-based lottery game. For example, a player may be allowed to continue until the avatar 410 is eaten or defeated by another player avatar 420 in the fish tank. Moreover, the triggering event may comprise achieving a certain total collection of awards 440 or credits, winning a certain number of awards 440, or engaging in a certain predetermined number or sequence of events in the virtual world of the network-based lottery game. Moreover, the triggering event may comprise depletion or other adjustments of attributes assigned to an avatar 410. One or more intervening triggering events occurring during play of the network-based lottery game may further adjust the length of time that a player avatar 410 participates in the network-based lottery game. For example, various intervening triggering events may add time to a player's bonus time meter, subtract time therefrom, increase or decrease certain player parameters, etc. In the event that the player account parameters change, the player avatar 410 will change accordingly using visual characteristic(s) and attributes to reflect the changes in player profile parameters.

In yet other embodiments, the network-based lottery game may take on many other forms, themes, configurations, and designs. In alternative embodiments, the network-based lottery game may involve group play, such as team play, competition, or collaborative efforts where the player avatar 410 interacts with other player avatars 420. In yet other alternative embodiments, the network-based lottery game may include adventures, episodes, or experiences in a variety of virtual worlds, arenas, or atmospheres. The network-based lottery game can take on virtually any form which allows the player to actively or passively participate and collect awards. The network-based lottery game may include animations, sounds, and entertaining content accompanying the display of the player avatar 410 interacting with the virtual world 405 displayed or contained therein. Moreover, the network-based lottery game may be organized in stages, levels, scenes, episodes, etc. such that a player avatar 410 may progress through different portions of the game. In yet other embodiments, players may be permitted to customize their avatar based upon assets or attributes collected, either through play of additional lottery games, network-based lottery games, or elsewhere, or as a result of purchase or grant. In limited circumstances, the network-based lottery game may also permit the player to collect, improve, use, or otherwise change the attributes of his or her player avatar during play.

In one alternative embodiment, the virtual world 405 of the network-based lottery game may be a flat, two dimensional map, wherein a player participating in the game is permitted to place an icon, such as a push-pin, on a particular location on the map (e.g., staking out a territorial claim). As additional validation codes are entered, the radius of the push-pin (i.e., attribute) may grow, or the player may be given an additional push-pin to place. In this way, player participation in the game comprises staking out a claim or territory, in hopes that it will be more favorably awarded (or randomly selected) at a future time. This also provides the player to observe their own progress, parameters, and advancement alongside other players simultaneously. Players may also be allowed to customize and filter their virtual environment views by specifically selecting friends, social network members, or groups to collectively compete or correlate for prizes and awards. Future (random) selection of specific points on the map to grant awards or prizes to a player covering that region may be routinely generated by the lottery authority on a periodic basis, or be initiated by the player. The network-based lottery game may allow user initiated lottery draws of this type until a given deadline, at which point, the lottery authority optionally exhausts the draws simultaneously.

In one embodiment, a player account with a corresponding avatar 410 has a defined life span and a given current credit value, both measurable parameters of the player profile. At a time of the designer's choosing, the player may be given an option to “cash out” and trade the current credit value for money, prizes, or other awards. This may be permitted at any time, at one or more specific times during the network-based lottery game, or may be limited to a time when the network-based lottery game terminates.

In one embodiment, the player has the option to customize the avatar 410, potentially upgrading the avatar 410 to compete for enhanced or additional prizes (i.e., buy up to a higher possible win value). In another embodiment, the player is permitted to purchase (or win) additional or enhanced virtual items (e.g., fish decorations), that may or may not impact the probability of winning prizes, changing appearance of the avatar 410, or changing the outcome of the network-based lottery game. Players may also be able to purchase extensions to the life (e.g., duration) of their avatar 410 in the network-based lottery game, or continue to interact with the network-based lottery game by supplying additional validation codes to boost one or more parameters of the player profile.

In one embodiment, the player avatar 410 may navigate a virtual environment 405 of networked fish tanks, where the player avatar 410 may progress (or “escape”) to a progressive series of tanks increasing in value as advancement of one or more parameters occurs. In another embodiment, player avatar 410 may encounter and consume other player avatars 420, thereby capturing the winnings collected by the other players until a final set of lottery winners remain.

The network-based lottery game may also include advancement multimedia processes and sequences, for example, including an enhanced highlight replay video of the player avatar 410 in action, eating other fish, gathering awards, etc.

In one embodiment, an additional wager, profile attribute, or a network-based lottery game random or triggered event may permit a player to perform a “Lucky Diver” bonus, where a deep sea diver appears to perform actions resulting in possible enhanced wins.

In one embodiment, the player avatar 410 is specifically generated and designed to impart a clear visual indication of a value of one or more parameters of a player profile. In one sense, the player avatar 410 takes a graph or measurement of relative strength or position and displays it as an “avatar” having strength or size attributes and visual characteristics. As the player interacts with the virtual environment 405 (and/or the network-based lottery game as a whole), the player avatar is enhanced or maintained. For example, continued registration of validation codes for second chance lottery ticket drawings may be required to maintain or enhance winning potential; the more second chance drawings you enter the bigger/stronger the player avatar 410 becomes with respect to other avatars 420, where the other avatars 420 are friends, computer generated make believe avatars, or a random pool of actual players. The player avatar may require continued interaction with the account to keep the avatar eligible for prizes. The strength or size of your avatar may be directly connected to the likelihood of a win or some other function. The second chance awards or drawings may be food dropped into the tank or coins that are collected. The use of the interactive avatar 410 may be used to interface with a lottery player to indirectly display and provide a table of odds or a chart of data of some likelihood of a result.

In one embodiment, a portion of a prize pool for lottery tickets is dedicated for second chance prizes. In response to a consumer purchasing a lottery scratch ticket, the consumer can become a player in a network-based lottery game by going to a website, authenticating, and entering the promotion by entering or scanning the ticket/code, optionally with a mobile device. One example is “activating” a fish which may be fed and interacted with via the virtual environment of the network-based lottery game. The fish has a defined lifespan and may convert into a prize value, either from a predetermined outcome or an outcome determined later during the network-based lottery game, for example, by drawing(s) initiated by the active players/codes, or as a result of additional codes being provided. Additional interaction with the fish may be required or advantageous, to maintain or grant eligibility for one or more of the secondary games. The fish may be customized, upgraded, accompanied with additional fish, etc., all of which may alter the probability of winning with the fish. That is, the purchase of upgrades or additional features for the fish may fund an increase the chance or amount which can be won by the fish. Fish may award prize(s) to a player over time generated from a preliminary entry of one or more fish or one or more games during a specified time period, even while the player is “away” (not actively engaged with the network-based lottery game).

In one embodiment, each fish may have a set of logic associated with it, providing a way for the system to allow the fish to have artificial intelligence driven outcomes determined while the player is not actively engaged with the network-based lottery game (i.e., while the player is away). One such set of fish logic may dictate while the player is away, differing behavior of probabilities are employed to determine eligibility or drawing success. This may further be influenced by attributes of the player profile/fish that impact awarding monetary and/or non-monetary awards accrued to the player. In these cases, the player would be notified of any accrued awards when logging back into the network-based lottery game, or by an automatically generated notification message such as electronic mail, SMS message, or another type of “push notification”.

Specific codes may indicate a predetermined outcome in that the code represents a given amount that can be awarded all at once or over time during the life of the fish. Other codes may indicate awards to be determined later by providing a predetermined number of draws in an online drawing for prize(s); for example, defining the lifespan of the fish as one-hundred minutes where one drawing is made every minute for one-hundred minutes. Each drawing may determine a distribution of the prize funds for a chosen fish. Draws may be a singularly made draw or may span multiple draws over a given period of time. A fish may accrue a potential value for awarding which is granted upon a successful drawing. Player interaction with the fish may be required to maintain eligibility for a given drawing, for the final drawing, etc. The potential for multiple levels of eligibility may also be incorporated and integrated to enable maintaining eligibility for a variety of prizes and/or games independently and simultaneously. Further, player interaction may include impact to weighting and/or amount of awarded prizes based on the amount and/or type of interaction.

In one embodiment, a player may be awarded “food pellets” in exchange of actual monetary prizes. The food pellets may be used by the player to initiate a lottery drawing to take place at a time of their choosing. A portion of these pellets may “drop to the bottom of the tank” and either be recycled and granted again to one or more players, or may be completely removed from circulation. A network-based lottery game may be specifically designed to award a given percentage of the funding pool to the players. For example, a network-based lottery game may be constructed to return 90% of the pellets to the players as a result of their (and others') interaction with the network-based lottery game. As long as the fish are in the tank and are properly eligible during a given time period, it is possible that a fish may eat a number of pellets during a given time period while the player is not active. A player may be otherwise not eligible for actual prizes unless a number of pellets are obtained. In this case, the pellets may not award prizes per se, but instead, provide additional pellets which may be put into the tank to be eaten by other (eligible) fish for prize awarding, or grant eligibility to one or more player avatars. This enables the “churning” of opportunities for a player avatar fish to eat pellets, where some of the pellets are gathered as a result of other player's dropped pellets. Further, for example, a player avatar fish may be given an opportunity to play an additional game online, receive additional ticket, etc., upon eating an amount of pellets monetarily equivalent to the cost of a lottery ticket. In other examples, as the fish “grows” or advances, in addition to visual cues and attributes being incorporated into the fish rendering, it may be possible to be transferred to another tank where the game/odds are different, perhaps enabling progression into bigger tanks for greater awards or giving the player an option to quit for a given static amount.

The span of costs of the lottery ticket(s) involved may additionally include the ability to amass enough “credits” to obtain lottery ticket(s) or codes at a higher or lower denomination from the game which the player entered into the network-based lottery game from. For example, a player avatar resulting from a validation code on a ten dollar lottery ticket may either start out larger or eat pellets at a much higher rate than a fish resulting from a validation code provided on a two-dollar lottery ticket.

Secondary and additional awards may also be incorporated into the prize pool, including an experience trip or a trip to a game show or trade show, for marketing purposes. In addition to a draw, other activities may include other interactions with the avatar, the avatar may have a gained (or intrinsic) value which may be cashed in for credits, or use a corresponding identifier associated with the avatar to award one or more additional features, like game show participation, game show eligibility, game show attendance, etc.

The network-based lottery game(s) may also be pari-mutuel. The amount of the network-based lottery game pool may be a predetermined amount and/or a contribution by “unclaimed prizes” of the primary lottery game pool.

In one embodiment, the network-based lottery game utilizes a three dimensional model of the fish tank (e.g., a polygon), and selection of a given selected point to determine a “hooked” fish, an “eaten” fish, a “fed” fish, or an otherwise “selected” fish. The chosen fish(es) may be randomly given awards (or removed from play to create a “survival” or last fish standing game outcome). Fish maybe eaten or eat other fish at specific intervals or times during the day or during the network-based lottery game. Other possibilities include a player selecting a “go hunting” button resulting in either eating/being eaten by another fish.

In one embodiment, after entry into the network-based lottery game, there is an associated monetary value with the entry. The value of the entry is ultimately being wagered and distributed to other players randomly, on a regular basis, for example, by player initiated draws. Players initiate a lottery drawing and a subsequent determination of “who wins each lottery draw wager” is made in response. Players trigger and initiate the drawing(s) (e.g., dropping of coins into a fountain, food pellets into a fish tank, push pins on a map, etc.), wherein the amount (of coins, pellets, pins, etc.) is determined by a funding source for the lottery game (e.g., allocated portion of initial lottery ticket price), and the value (of the individual coins, pellets, pins, etc.) is distributed to winning players as a result of each draw. The initiating player may or may not benefit from the draws the player personally initiates. When the round elapses, time runs out, game ends, etc., a final drawing may occur to force payout of the value of the outstanding draws to one or more players of the network-based lottery game.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of indicating player account parameters using visual characteristics on an electronic display device coupled to a network, the method comprising:
in response to receiving a wager amount, issuing a lottery ticket including a unique activation code;
receiving, by game-logic circuitry and responsive to a physical input on an electronic input device by a player, an activation request activating the activation code associated with the lottery ticket;
linking, by the game-logic circuitry, the activated activation code to a player-accessible account associated with a virtual character,
establishing, by the game-logic circuitry, one or more visual characteristics for the virtual character based, at least in part, on measurable parameters of the player account;
providing, by the game-logic circuitry, a player-interactive virtual environment including the virtual character by generating display information for rendering the virtual environment and the visual characteristics of the virtual character on the electronic display device; and
directing, by the game-logic circuitry, the electronic display device to update the virtual environment and the visual characteristics of the virtual character based, at least in part, on changes in the parameters of the player account.

2. The method of claim 1, wherein linking the activated activation code to the player-accessible account increases one or more of the parameters of the player account based upon the wager amount.

3. The method of claim 1, wherein the display information specifies that the virtual environment contains a plurality of other virtual characters.

4. The method of claim 3, wherein the display information further specifies that each other virtual character reflects one or more visual characteristics based, at least in part, on measurable parameters of a respective other player account.

5. The method of claim 4, wherein the respective other player account is associated with the player-accessible account.

6. The method of claim 1, further comprising, in response to the player interacting with the virtual environment, awarding a tangible award to the player.

7. The method of claim 1, wherein the measurable parameters of the player account are selected from a group consisting of a number of activated activation codes linked to the player-accessible account, a currency value of the player account, a number of winning network-based lottery game random draws, or a time duration indicator.

8. A system for implementing a network-performed indication of player account parameters using visual characteristics on an electronic display device coupled to a network following issuing a lottery ticket including a unique activation code in response to receiving a wager amount, the system comprising game-logic circuitry comprising one or more processors, at least one storage medium, and at least one communication interface coupled to the network, the game-logic circuitry configured to:
receive, responsive to a physical input on an electronic input device by a player, an activation request activating the activation code associated with the lottery ticket;
link the activated activation code to a player-accessible account associated with a virtual character;
establish one or more visual characteristics for the virtual character based, at least in part, on measurable parameters of the player account;
provide player interaction with a player-interactive virtual environment including the virtual character by generating display information for rendering the virtual environment and the visual characteristics of the virtual character on the electronic display device; and
direct the electronic display device to update the virtual environment and the visual characteristics of the virtual character based, at least in part, on changes in the parameters of the player account.

9. The system of claim 8, wherein linking the activated activation code to the player-accessible account increases one or more of the parameters of the player account based upon the wager amount.

10. The system of claim 8, wherein the display information specifies that the virtual environment contains a plurality of other virtual characters.

11. The system of claim 10, wherein the display information specifies that each other virtual character reflects one or more characteristics based, at least in part, on measurable parameters of a respective other player account.

12. The system of claim 11, wherein the respective other player account is associated with the player-accessible account.

13. The system of claim 8, wherein the game-logic circuitry is further configured to, in response to the player interaction with the virtual environment via the virtual character, award a tangible award to the player.

14. The system of claim 8, wherein the measurable parameters of the player account are selected from a group consisting of a number of activated activation codes linked to the player-accessible account, a currency value of the player account, a number of winning network-based lottery game random draws, and a time duration indicator.

15. A method of indicating player-accessible account characteristics on an electronic display device coupled to a network by providing a graphical user interface displaying a player-interactive virtual environment, the method comprising:
in response to receiving a wager amount, issuing a lottery ticket including a unique activation code;
receiving, by the game-logic circuitry and responsive to a physical input on an electronic input device by a player, an activation request over the network from the player to activate the activation code associated with the lottery ticket;
linking, by the game-logic circuitry, the activated activation code to the player-accessible account associated with a virtual character,
establishing, by the game-logic circuitry, one or more characteristics for the virtual character based, at least in part, on measurable parameters of the player account;
generating, by the game-logic circuitry, information defining features of the virtual environment and transmitting the information over the network for display of the graphical user interface to the player;
providing, by the game-logic circuitry, a player-interactive virtual environment including the virtual character using the graphical user interface by generating display information for rendering the graphical user interface including the virtual environment and the visual characteristics of the virtual character on the electronic display device; and
directing, by the game-logic circuitry, the electronic display device to update the graphical user interface, the virtual environment, and the one or more characteristics of the virtual character based, at least in part, on changes in the parameters of the player account.

16. The method of claim 15, wherein linking the activated activation code to the player-accessible account increases one or more of the parameters of the player account based upon the wager amount.

17. The method of claim 15, wherein the display information specifies that the virtual environment contains a plurality of virtual characters each reflecting one or more characteristics based, at least in part, on measurable parameters of a respective plurality of player accounts.

18. The method of claim 17, wherein at least one of the respective other player accounts are associated with the player-accessible account.

19. The method of claim 15, further comprising, in response to the player interaction with the graphical user interface, awarding a tangible award to the player.

20. The method of claim 15, wherein the measurable parameters of the player account are selected from a group consisting of a number of activated activation codes linked to the player-accessible account, a currency value of the player account, a number of winning network-based lottery game random draws, or a time duration indicator.
